(19) United States
(12) Patent Application Publication
(10) Pub. No.: US 2012/0283958 A1
(43) Pub. Date: Nov. 8, 2012

(54) GENERALIZED NETWORK THREADING APPROACH FOR PREDICTING A SUBJECT'S RESPONSE TO HEPATITIS C VIRUS THERAPY

(75) Inventors: Rajeev Aurora, Wildwood, MO (US); John Edwin Tavis, Kirkwood, MO (US)

(73) Assignee: SAINT LOUIS UNIVERSITY, St. Louis, MO (US)

(21) Appl. No.: 13/454,673

(22) Filed: Apr. 24, 2012

Related U.S. Application Data
(60) Provisional application No. 61/481,949, filed on May 3, 2011.

(51) Int. Cl. G06F 19/00

(52) U.S. Cl. 702/20

(57) ABSTRACT

Methods for predicting a response of a virus to an antiviral therapy are provided.

### CROSS REFERENCE To RELATED APPLICATIONS

The present application claims the benefit of priority from U.S. Provisional patent application no. 61/481,949 entitled “GENERALIZED NETWORK THREADING APPROACH FOR PREDICTING A PATIENT′S RESPONSE TO HEPATITIS C VIRUS THERAPY” and filed on 3 May 2011, the contents of which are hereby incorporated by reference in their entirety to the extent permitted by law.

### STATEMENT OF GOVERNMENT SUPPORT

This work was funded in part by grants DK60345 and DK074515 from the National Institutes of health. The United States Government may have certain rights in the invention.

### BACKGROUND

About 3.8 million Americans are chronically infected with Hepatitis C virus (HCV), and the Centers for Disease Control and Prevention estimate that hepatitis C causes 8,000-10,000 deaths each year in the USA. Currently, the best therapy for HCV infection is a combination of pegylated interferon α and ribavirin, a guanosine analogue. Treatment with these drugs for 24 to 48 weeks leads to sustained clearance of the virus and stabilization of liver function in 50-60% of genotype 1 subjects (Manns, M. P., et al., Lancet 358, 958-965, 2001; Hadziyannis, S. J., et al., Ann. Intern. Med. 140, 346-355, 2004). Interferon (IFN) alpha provides the primary antiviral effect during therapy and can clear HCV even when used alone (Poynard, T., et al., Lancet 352, 1426-1432, 1998; McHutchison, J. G., et al., New England J. Med. 339, 1485-1492, 1998). Ribavirin cannot eliminate viremia by itself (Bodenheimer, H. C., et al., Hepatology 26, 473-477, 1997; Dusheiko, G., et al., J. Hepatol. 25, 591-598, 1996; Di Bisceglie, A. M., et al., Ann. Intern. Med. 123, 897-903 1995), although it can reduce viral titers slightly in some subjects (Pawlotsky, J. M., et al., Gastroenterology 126, 703-714, 2004). When ribavirin is taken in combination with IFN alpha, it roughly doubles the viral clearance rate (McHutchison, J. G., et al., New England Journal of Medicine 339, 1485-1492, 1998; Poynard, T., et al., Lancet 352, 1426-1432, 1998; Davis, G. L., et al., New England J. Med. 339, 1493-1499, 1998), apparently by reducing relapse following the end of drug treatment. Recently, two direct inhibitors of the HCV NS3/4A polymerase have been added to the treatment paradigm, boceprevir and telaprevir (Rice, C. 2011. Perspective: miles to go before we sleep. Nature 474:S8). The compounds have cut the failure rate for treatment of HCV in half, but failure is still common and therapy still relies on interferon α.

The HCV genome is an approximately 9,600 nucleotide long RNA that encodes a single polyprotein of about 3010 amino acids. The polyprotein is post-translationally cleaved by host and viral proteases to produce ten mature viral proteins. The core, E1, and E2 proteins form the virion, and P7-NS5B are nonstructural proteins with regulatory and/or enzymatic functions. The HCV genome is highly variable, and six HCV genotypes that are less than 72% identical at the nucleotide level have been identified (Simmonds, P. et al., J. General Virol. 74, 2391-2399, 1993; Bukh, J., et al., Seminars in Liver Disease 15, 41-63, 1995; Robertson, B., et al., Archives Virol. 143, 2493-2503, 1998; Simmonds, P., et al., Hepatology 42, 962-973, 2005; Bukh et al., 2005; Simmonds, P., J. Gen. Virol. 85, 3173-3188, 2004). Within these genotypes, subtypes with identities of 75-86% may occur. HCV replicates as a quasispecies rather than as a clonal population, and hence multiple closely-related HCV variants exist within individual subjects. The quasispecies develops because the viral production rate is very high [about 10¹² virions per day; (Neumann, A. U., et al., Science 282, 103-107 1998)] and the viral RNA polymerase has low fidelity. Therefore, new mutations are constantly introduced into the viral pool, and each of these variant genomes is in competition with the others (Kurosaki, M. et al., Virology 205, 161-169, 1994; Zeuzem, S., Forum (Genova) 10, 32-42, 2000). The result is that at any given time, one or a few genomes will be dominant because they are the fittest for the prevailing conditions, as defined by host physiology, immune status, and antiviral drug challenge. The quasispecies distribution can vary with time through adaptive or neutral evolution (Simmonds, P., J. Gen. Virol. 85, 3173-3188, 2004). Adaptive changes are due to emergence of more fit variants as conditions facing the virus change. Neutral changes result from replacement of sequences with others of equivalent fitness. The high genetic variability of HCV has two fundamental biological effects. First, it provides diversity for rapid viral evolution in response to selective pressures, such as an immune response or antiviral pressure. Second, the diversity causes many viral genomes to contain variations that are either lethal or reduce fitness, leading to their loss from the viral population.

HBV is a small enveloped virus with a partially double-stranded DNA genome that is replicated by reverse transcription. Four sets of viral mRNAs encode 7 proteins: 3 surface glycoproteins (HBsAgs), a capsid protein (HBcAg), a secreted regulatory protein (HBeAg), a reverse transcriptase, and an intracellular regulatory protein (HBx). The surface glycoproteins contain the conserved immunodominant “a” epitope that is the target of protective antibodies elicited by the vaccine. Upon infection, HBV's genome is converted to the covalently-closed circular DNA (“cccDNA”) in the nucleus, which is the template for transcription of the viral mRNAs. The RNA form of the genome is encapsidated along with the reverse transcriptase, and reverse transcription occurs in the cytoplasm. Nascent viral capsids either enter the nucleus to maintain the cccDNA pool or bud through cellular membranes and are secreted from cells non-cytolytically as virions. Two forms of antiviral therapy exist. Interferon α triggers cellular effectors that suppress viral replication, and the nucleoside/nucleotide analogs block reverse transcription. HBV therapy is plagued by limited efficacy, with neither therapy curing the infection and severe side effects for interferon α (Kwon, H. and A. S. Lok. 2011. Hepatitis B therapy. Nat. Rev. Gastroenterol. Hepatol. 8:275-284). HBV has 8 genotypes (A-H) that differ by 8% at the nucleotide level, and the genotypes have moderate differences in their response to therapy (Palumbo E. Hepatitis B genotypes and response to antiviral therapy: a review. Am J Ther 2007 May;14(3):306-309).

The Viral Resistance to Antiviral Therapy of Chronic Hepatitis C clinical study (Virahep-C) investigated the efficacy of pegylated IFN alpha plus ribavirin for treating hepatitis C (Conjeevaram, H. S., et al., Gastroenterology 131, 470-477, 2006.). As part of Virahep-C, a viral genetics study was performed to identify viral genetic patterns associated with response or failure of therapy and to determine which viral genes are targets of antiviral pressures induced by therapy (Donlin, M. J., et al., J. Virol. 81, 8211-8224, 2007). The complete HCV ORF from 94 subjects was sequenced before therapy, stratified based on response to therapy at day 28 (Marked, Intermediate, or Poor responders) and genotype (1a or 1 b). It was found that viral genetic variability in sequences from the marked responders (in whom therapy efficiently suppressed viral titers) was much higher than in the poor responders (in whom suppression of the virus was minimal or absent). These genetic variability differences were found primarily in the viral NS3 and NS5A genes for genotype 1a and in core and NS3 for genotype 1b. Importantly, core, NS3, and NS5A all have functions in cultured cells that can counteract the effect of interferon a, the dominant drug during HCV therapy (Gale, M., and Foy, E. M., Nature 436, 939-945, 2005). Similar results were obtained with the eventual outcome of therapy (Donlin M. J., Cannon, N. A., Aurora, R., Li, J. Wahed, A., Di Bisceglie, A. M., and Tavis, J. E., PLoS One 5, e9032, 2010). It is believed that the association of higher diversity with response to therapy implies that the virus in poor responders survived because there are only a few ways to optimize activity of the viral proteins, but many ways to interfere with their function.

U.S. patent application publication No. 2008/0318207 discloses a method for predicting a response of a virus to therapy. The method relies on identification of one or more covariance pairs that are most connected to other amino acid positions in responder and non-responder alignments of viral isolates, and determining whether the test virus contained these same covariance pairs. Thus, the method only looks at one or more single amino acid positions, and the actual amino acids contained therein.

### SUMMARY

In one aspect, a method for screening a test virus in a subject for responsiveness to an antiviral therapy, the method comprising the steps of: sequencing at least a portion of the genome of the test virus contained in a biological sample from the subject; aligning a test sequence from the test virus to the sequences of a reference responder alignment, to form a test virus responder alignment, and generating a test virus responder network based on covariance pairs identified in the test virus responder alignment; aligning the test sequence to the sequences of a reference non-responder alignment, to form a test virus non-responder alignment, and generating a test virus non-responder network based on covariance pairs identified in the test virus non-responder alignment; measuring a responder difference between the test virus responder network and a reference responder network and comparing the responder difference to a reference responder difference; measuring a non-responder difference between the test virus non-responder network and a reference non-responder network and comparing the non-responder difference to a reference non-responder difference, wherein a responder difference greater than the non-responder difference indicates that the test virus is responsive to the antiviral therapy.

In another aspect, a method for screening a test virus in a subject for responsiveness to an antiviral therapy is provided. The method comprises the steps of: sequencing at least a portion of the genome of the test virus contained in a biological sample from the subject; aligning a test sequence from the test virus to the sequences of a reference responder alignment, to form a test virus responder alignment, and generating a test virus responder network based on covariance pairs identified in the test virus responder alignment; aligning the test sequence to the sequences of a reference non-responder alignment, to form a test virus non-responder alignment, and generating a test virus non-responder network based on covariance pairs identified in the test virus non-responder alignment; measuring a responder difference between the test virus responder network and a reference responder network and comparing the responder difference to a reference responder difference; measuring a non-responder difference between the test virus non-responder network and a reference non-responder network and comparing the non-responder difference to a reference non-responder difference, wherein: the responder difference and the non-responder difference are each measured with the OMES score and the number of hydrophobic pairs, and as measured by both OMES score and number of hydrophobic pairs, a responder difference greater than the non-responder difference indicates that the test virus is responsive to the antiviral therapy.

In a further aspect, a system for screening test viruses for responsiveness to an antiviral therapy is provided. The system comprises: means for sequencing test virus genes; a computer readable memory medium, and at least one processor operable to access from the computer readable memory medium program instructions executable by the processor to: align a test sequence from a test virus to the sequences of a reference responder alignment, to form a test virus responder alignment, and generate a test virus responder network based on covariance pairs identified in the test virus responder alignment; align the test sequence to the sequences of a reference non-responder alignment, to form a test virus non-responder alignment, and generate a test virus non-responder network based on covariance pairs identified in the test virus non-responder alignment; measure a responder difference between the test virus responder network and a reference responder network and compare the responder difference to a reference responder difference; measure a non-responder difference between the test virus non-responder network and a reference non-responder network and compare the non-responder difference to a reference non-responder difference.

Other objects and features will be in part apparent and in part pointed out hereinafter.

### BRIEF DESCRIPTION OF THE FIGURES

FIG. 1 illustrates a flow diagram illustrating steps applied by an example method.

FIG. 2 illustrates the scheme of an example algorithm for classifying an HCV isolate.

FIG. 3 illustrates the scheme of an example algorithm for classifying an HCV isolate as a responder or non-responder.

### DEFINITIONS

As used herein, an “antiviral therapy” may include the administration of one or more antiviral therapeutic agents, such as small molecule drugs, peptides, and antibodies. Example antiviral therapeutic agents include interferon, ribavirin, boceprevir, and telaprevir.

As used herein, the articles “a,” “an,” “the,” and “said” are intended to mean that there are one or more of the elements referred to by an article. The terms “comprising,” “including,” and “having” are intended to be inclusive and mean that there may be additional elements other than the listed elements.

### DETAILED DESCRIPTION

Many of the amino acid positions in open reading frames (ORFs) of viruses such as the HCV and HBV vary in concert with other positions in the genome. This coordinated variation concept is referred to as “covariance,” i.e., covariance refers to coordinated variation of two residues among a collection of related sequences. Thus, “covariance pairs” refer to two amino acid positions that covary among a collection of related sequences. The amino acid residue positions exhibiting covariance within a biological system, such as a viral genome, can be related in a “covariance network,” i.e. a weighted undirected graph within the context of graph theory. The representation of the network comprises nodes, i.e. the positions of the amino acids in an alignment of related sequences, and edges symbolizing covariance, i.e. that the nodes linked by an edge exhibited coordinated variation.

Networks can also have “hub” amino acid residue positions, wherein each hub exhibits covariance with multiple other amino acid residue positions. As used herein, a hub residue position is a node with 5 or more edges, i.e., a hub amino acid residue position exhibits covariance with at least 5 other amino acid residue positions. A node that is connected to a node-of-interest is called a “neighbor.” The term “spoke” refers to an edge connecting a hub to one of its neighbor nodes. By way of example, networks based on the HCV genome usually have a “hub-and-spoke” architecture, with a few nodes (e.g., positions in the alignments) covarying with many others (hubs), but most nodes being connected to only few others.

As used herein, the terms “responder,” responding,” “responsive,” and “susceptible to antiviral therapy” refer to viruses for which a given antiviral therapy suppresses viral titers substantially, whereas “non-responder,” “non-responding,” “non-responsive,” “poor responder,” “not susceptible to antiviral therapy” and “resistant to antiviral therapy” refer to viruses for which the antiviral therapy induced minimal or no suppression of viral titers. In one example, the antiviral therapy suppresses viral titers for at least six months following drug withdrawal in responder strains. The inventors have discovered that responder viral isolates and poor-responder viral isolates form discrete genome-wide networks of covarying amino acids pairs, linking the covariance to antiviral therapy response. Furthermore, the non-responders tend to have more hydrophobic amino acids, such as valine (Val), isoleucine (Ile), leucine (Leu), methionine (Met), phenylalanine (Phe), tryptophan (Trp), tyrosine (Tyr), alanine (Ala) and cysteine (Cys) in the covarying pairs than the responders. Lysine-lysine and argininine-arginine pairs are also considered hydrophobic interactions (also known as “hydrophobic pairs”). Hydrophobic interactions contribute much more to protein stability in an aqueous environment than hydrophilic interactions; thus, while not being bound to a theory, it is believed that the potential for greater stability provided by the higher hydrophobic nature of the interactions may allow some of the viruses in the population to better survive the pressures introduced by the antiviral therapy.

As the inventors have discovered, such networks are also useful for determining characteristics of a test virus by measuring the effects of its amino acid sequences on already established networks based on covariance pairs. As described herein, stabilization or destabilization of a network by the addition of a sequence from a test virus can be indicative of whether the test virus may be characterized as having a given feature in common with the viral isolates on which the network is based. The stabilization or destabilization of the network may be measured by metrics (also known as “network parameters” in the context of graph theory) that are directly proportional to a network's stability.

Accordingly, in one aspect, methods are provided for screening a test virus on the basis of its predicted response to a therapy based on a given antiviral agent(s). A first, reference covariance network is provided. The reference covariance network is established from an alignment of reference sequences from viral isolates with a known outcome for the therapy. A test sequence from a test virus whose response to the antiviral therapy is to be predicted is added to the reference set and a second, test network is displayed. The network metrics in the reference network are then compared with those of the test network containing the test sequence.

The inventors have found that, if the size of the reference network is small enough to render it metastable, and hence sensitive to stabilization or destabilization by addition of the test sequence, then an increase in the network metrics by more than the amount predicted by random chance is indicative of the fact that the test sequence has stabilized the network structure. Conversely, a decrease by more than the amount predicted by random chance indicates a destabilization of the network. The resulting stabilization or destabilization of the network due to the inclusion of the test virus sequence thus provides information about the ability of the test virus to respond to the antiviral therapy.

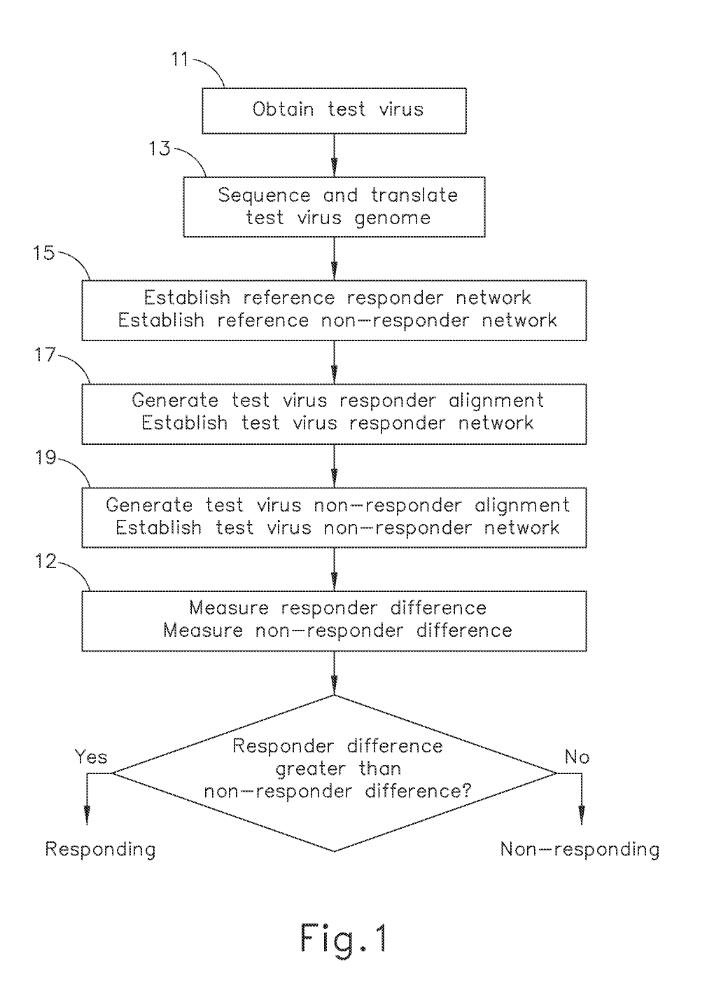

FIG. 1 is a flow diagram illustrating steps applied by an example method. A test virus is obtained, for instance from a biological sample taken from a subject by conventional biopsy techniques (block 11). The biological sample may include, for example, blood, serum, a biopsy sample, a tissue sample, a cell suspension, saliva, oral fluid, cerebrospinal fluid, lymph, urine, gastric fluid, synovial fluid, mucus, sputum, and the like. By way of example, a sample of venous blood may be taken from the subject via venopuncture. Serum samples can then be analyzed for presence of a virus, e.g., by nested PCR techniques, ELISAs, or strip-western blots.

Once the test virus is obtained, at least a portion of its genome is sequenced using any of the known methods and/or apparatuses and translated into a predicted amino acid sequence, as illustrated in block 13. By way of example and not of limitation, ABI Dye Terminator Technology (Applied Biosystems, Foster City, Calif.), 454 Pyrosequencing (454 Life Sciences, Branford, Conn.), or Illumina Sequencing (Illumina, San Diego, Calif.) may be used to sequence test virus genes.

A reference responder alignment and a reference non-responder alignment are provided. Amino acid sequences of viral isolates responsive to the antiviral therapy are aligned in a reference responder alignment, and sequences of viral isolates non-responsive to the therapy are aligned in a reference non-responder alignment. The alignments may include either full or partial genome sequences. When an alignment is performed over partial genomes of viral isolates rather than over the whole genome length, the choice of select partial genomes to be used may be based on characteristics such as proteins which the partial sequences encode, biological importance, sequence identity among different isolates, antiviral therapy that is used, immunological status of a subject, and the like. In some cases, the partial genomes used for alignments may be at least 1000 amino acids long, and in other cases at least 2000 amino acids long.

Multiple sequences may be aligned, for example, by using Clustal W (Jeanmougin, F., et al., Trends Biochem. Sci. 23, 403-405, 1998) as previously described (Donlin, M. J., et al., J. Virol. 81, 8211-8224, 2007), or any programs for aligning multiple amino acid sequences that are known in the art. In some cases, an alignment may contain at least 5 aligned amino acid sequences from responding viral isolates. For instance, the alignment may contain from 5 to 30 aligned sequences from viral isolates. Specifically, it may contain at least about 5, 6, 7, 8, 9, 10, 11, 12, 13, 14, 15, 16, 17, 18, 19, 20, 21, 22, 23, 24, 25, 26, 27, 28, 29 or 30 aligned amino acid sequences from viral isolates. In representative cases, an alignment may contain at least 15 aligned amino acid sequences from viral isolates.

Covarying pairs of amino acid positions are then identified in each alignment. By way of example and not of limitation, three previously published algorithms may be used to identify covarying positions (Olmea, O., et al., J. Mol. Biol. 293, 1221-1239, 1999; Atchley, W. R., et al., Mol. Biol. Evol. 17, 164-178, 2000; Kass, I., and Horovitz, A., Proteins 48, 611-617, 2002). Empirically, it has been found that, in designing algorithms that measure correlated variations, it is preferable to favor an intermediate level of conservation because a balance should exist between false positives at nonconserved positions (where a random frequency of amino acids is observed), and false negatives (from positions where residues are completely conserved). For example, the HCV genome contains many positions that are completely conserved, with islands of variable positions.

Following identification of covarying pairs, such information is used to establish networks. A reference responder network is established based on the covariance pairs identified in the test virus responder alignment, and a reference non-responder network is established based on the covariance pairs identified in the non-responder alignment (block 15). For instance, the networks may be established by displaying the covarying pairs as graphs, where a graph is a collection of nodes (denoting amino acid positions) connected by edges (represented as lines) if the amino acids corresponding to the nodes display covariance. Graphs may be displayed for the covarying positions using Cytoscape (Shannon, P., et al., Genome Res. 13, 2498-2504, 2003). Alternatively, other graphing methods may be used to establish networks, including but not limited to AllegroGraph, Commetrix, Gephi, Graph-tool and the like. If available, previously established reference networks may be used.

An amino acid test sequence from the genome of the test virus is aligned to the amino acid sequences of the reference responder alignment, thereby generating a test virus responder alignment. Covariant pairs of amino acid residues in the test virus responder alignment are identified, and the resulting information is used to establish a test virus responder network, as illustrated in block 17. The test sequence is also aligned to the amino acid sequences of the reference non-responder alignment, thereby generating a test virus non-responder alignment. Covariant pairs of amino acid residues in the test virus non-responder alignment are identified, and a test virus non-responder network is established (block 19).

As illustrated in comparison block 12, a responder difference, which is defined as the difference between the test virus responder network and the reference responder network, is measured and compared to a reference responder difference, which is defined as the difference between the test virus responder network and the reference responder network as would be expected by random chance. Similarly, and also as illustrated in measuring block 12, a non-responder difference, which is defined as the difference between the test virus non-responder network and the reference non-responder network, is measured and compared to a reference non-responder difference, which is defined as the difference between the test virus non-responder network and the reference non-responder network as would be expected by random chance. If the responder difference is greater than the non-responder difference, the test virus is predicted to be responding to the viral therapy (YES in decision block 14). Conversely, if the non-responder difference is greater than the responder difference, the test virus is predicted to be non-responding to the antiviral therapy (NO in decision block 14).

The inventors have found that adding a responder virus sequence to a reference responder network improves the stability of the network, whereas adding a non-responder test sequence to a responder network leads to a decrease in stability. The converse, adding a responder test sequence to a non-responder reference network, also decreases the network stability, whereas adding a non-responder test to the non-responder reference network increases it. Usually, an increase in stability is above random chance only when a test sequence is added to a reference network that the test sequence belongs to (and, conversely, a decrease in the network properties more than expected by random chance when the test sequence is added to reference network of the opposing class). Such increases and decreases can thus be used as basis of prediction methods.

In measuring the stabilization or destabilization of a network, any property directly proportional to the stability of the network may be used, such as the number of nodes, the number of edges, the average edges per node or number of edges of specific nodes; as well as summing over edge properties such as the “hydrophobic pairs,” i.e. the number of hydrophobic interactions between the covariant pairs in the reference responder and non-responder network. Metrics of the following three classes have been found to be directly proportional to network stability: (i) metrics measuring a characteristic of nodes; (ii) metrics measuring a characteristic of edges; and (iii) metrics measuring a topology of networks. Rigorous descriptions of a number of metrics may be found in: Dong & Horvath, BMC Systems Biology, 2007, 1:24 and Christensen & Albert, International Journal of Bifurcation and Chaos, 2007, 17:2201-2214.

Empirically, it has been found that prediction may be done with any of the above three metrics, although more robust predictions have been obtained by using two metrics, where at least one is chosen from the above three metrics. The methods may be implemented by a computer having at least one processor operable to access computer executable instructions stored in a non-transient computer-readable memory medium, for instance a computer interfaced with an apparatus for sequencing genes.

Example characteristics of a node include its alignment position, centrality, amino acid identity, and physiochemical characteristics of the amino acid, such as its polarity, hydrophobicity, aliphatic character, or electric charge. The centrality of a node may be measured, for example, by measures of centrality that are widely used in network analysis, including: degree centrality, betweenness centrality, closeness centrality, and eigenvector centrality (Opsahl et al., Social Networks 32: 245, 2010). Other measures of centrality include eccentricity centrality, stress centrality, community centrality, dynamic centrality, and connectedness centrality.

Example characteristics of a network's edges comprise the number of edges in the network, the average edge length, and the “edge weight.” A network is said to be weighted if every edge is associated with a real number, called edge weight. The edge weight can be associated with a given property of the edges of a network; for example, the weight may be a measure of the strength of the covariance interactions associated with an edge. In this instance, the weight may be quantified by the observed minus expected square (OMES) method (Kass, I., and Horovitz, A., Proteins 48, 611-617, 2002) or other covariance quantification algorithms. Another example characteristic of the edges is the number of pairs in a network, i.e. the number of edges between nodes having a given property. A typical example is the number of hydrophobic pairs in a network, which is the number of edges that are between hydrophobic nodes. Also included is the number of sub-networks of a given order. Sub-networks of a network are networks whose nodes are subsets of the network and whose vertices are a subset of those of the network restricted to this subset. For instance, a sub-network of the third order contains three nodes and three edges, and can therefore be referred to as a “triangle,” a sub-network of the fourth order can be referred to as “square,” and so forth.

The topology of a network is a function of the spatial distribution of the edges of the network. It can be expressed in qualitative terms, such as ring, star, random Erdös-Rényi, hub-and-spoke, or hierarchical, usually depending on the visual appearance of the network or the method used for displaying the network. Quantitatively, the topology of a network is given by measuring the distribution of its edges. A number of metrics may be used to perform this measuring, the only requirement being that a given metric be suitable to measuring differences in topology between the test virus responder network and the reference responder network and differences between the test virus non-responder network and the reference non-responder network. The topology of a network may be quantitatively measured by metrics such as the γ-order, diameter, edge density, or any equivalent metric.

The methods find particular use in determining the appropriate therapy for a subject. As some of the available antiviral therapies have serious side effects and can be extremely costly, it would be of great advantage to both a clinician and subject if they could know before starting the therapy whether the subject will respond or not. For instance, the methods may be used to determine whether a subject with Hepatitis C will respond to therapy of example drugs, such as interferon a and ribavirin, or not. As the methods are non-invasive and simple (since it only requires sequencing of the partial or full genome of a subject's virus), they provide additional advantages for their application in clinical settings.

The applicability of the methods to a given virus species may be easily established by determining whether covariance networks for the virus can be found. If this is the case, then a reference responder and a reference non-responder networks for screening test viruses are displayed. Indeed, covariance networks have been found in a diverse set of viruses. In one study, viral sequences were obtained for 16 viruses in 13 species from 9 families, including Flaviviridae and other single-stranded positive-polarity RNA viruses, single-stranded negative-polarity RNA viruses, single-stranded mixed-polarity DNA viruses, and partially double-stranded DNA viruses. Covariances that spanned the viral coding potential were common in all viruses. Moreover, in all instances, the covariances formed a single network that contained essentially all of the covariances (Donlin et al., J. Virol. 2012, 86(6):3050). Covariance network analysis is thus applicable to any virus, and is especially suited to a virus which exhibits high genomic variability, is susceptible (responding) to antiviral therapy or is resistant (non-responding) thereto, and is treated with an antiviral therapy that applies a pleiotropic pressure on the virus.

Some non-limiting examples of viruses to which the methods can be applied include RNA viruses and DNA viruses, such as: positive-polarity single-stranded RNA viruses including Flaviviridae, such as Yellow fever virus, Dengue virus, West Nile virus, Japanese encephalitis virus, a Hepacivirus such as a Hepatitis C virus, and reverse-transcribing retroviruses such as HIV-1 and HIV-2; negative polarity segmented RNA viruses such as Influenza virus, strains of which infect humans or animals such as birds or swine; negative polarity unsegmented RNA viruses including Paramyxoviridae such as Measles virus, Respiratory Syncytial virus, and Mumps virus, as well as Rhabdoviridae such as rabies virus; positive polarity single-stranded RNA viruses including Picornaviridae such as rhinovirus (which causes the common cold, and for which over 100 strains are known), Enteroviruses such as Coxsackie virus, Echovirus, Hepatitis A virus, and Foot-and-mouth disease virus; double-stranded segmented RNA viruses, including Rotaviridae; partially double-stranded DNA viruses including Hepadnaviridae such as Hepatitis B virus; mixed positive and negative polarity single-stranded DNA viruses, including Parvoviridae such as B19 virus and the Canine and Feline Parvoviruses. In some embodiments, the virus is selected from the group consisting of Hepatitis B virus, Hepatitis C virus, SARS-Coronavirus, Coxsackie viruses, Respiratory Syncytial virus (RSV), Influenza viruses, and Human Immunodeficiency virus (HIV).

The methods disclosed herein may be operational with general purpose or special purpose computing system environments or configurations, for instance a computing system interfaced with an apparatus configured for sequencing virus genes. The computing system environment is not intended to suggest any limitation as to the scope of use or functionality of any aspect of the methods. Moreover, the computing system environment should not be interpreted as having any dependency or requirement relating to any one or combination of components illustrated in an exemplary operating environment. Examples of well known computing systems, environments, and/or configurations that may be suitable for use with the methods include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Algorithms implemented by the methods may be described in the general context of data and/or computer-executable instructions, such as program modules, stored one or more tangible computer storage media and executed by one or more computers or other devices. Program modules include, but are not limited to, routines, programs, objects, components, and data structures that perform particular tasks or implement particular abstract data types. Distributed computing environments where tasks are performed by remote processing devices that are linked through a communications network may are also contemplated. In a distributed computing environment, program modules may be located in both local and remote computer storage media including memory storage devices.

The methods may be implemented with computer-executable instructions. The computer-executable instructions may be organized into one or more computer-executable components or modules on a tangible computer readable storage medium. The methods may be implemented with any number and organization of such components or modules. For example, the methods are not limited to the specific computer-executable instructions or the specific components or modules illustrated in the figures and described herein. Some of the methods may include different computer-executable instructions or components having more or less functionality than illustrated and described herein.

### EXAMPLE ALGORITHM

In an example algorithm for the above-described methods, the responder difference and the non-responder difference are each measured with the OMES score and the number of hydrophobic pairs as metrics. Accordingly, a test virus can be predicted to be responding to an antiviral therapy if: (a) as measured in OMES score, the responder difference is greater than the non-responder difference, and (b) as measured in number of hydrophobic pairs, the responder difference is greater than the non-responder difference.

A reference responder alignment and a reference non-responder alignment are provided. In some cases, the sequences of viral isolates used in the alignments may be amino acid translations of Hepatitis C virus ORFs sequences, such as those of viruses having either 1a or 1b genotypes, whose sequences are readily available through databases such as Genbank. In one representative example, the length of the partial HCV genome sequences that are aligned may be at least 2045 amino acids. In another example, the partial HCV genomes that are aligned can span amino acids 380-2425 covering the proteins E1 through NS5A. The reference responder alignment may contain at least 15 amino acid sequences from responding HCV 1a or 1b isolates, and the reference non-responder alignment may contain at least 15 amino acid sequences from non-responding 1a or 1b isolates. These sequences can be obtained, for example, from Genbank EF407411 to EF407504. In other cases, the sequences of viral isolates may be amino acid translations of Hepatitis B virus ORF sequences from any of the 8 genotypes (A-H).

A reference responder network and reference non-responder network are also provided. Covarying pairs of amino acid positions are identified separately in reference responder and non-responder alignments, and the OMES score for every possible pair of positions in each alignment is calculated. The null model in this analysis is the expected number of covarying pairs, which is based on the count of each amino acid at each of the two positions of each pair of positions. Therefore, two perfectly conserved columns will have a score of zero because the expected and observed numbers are equal.

To identify the covarying pairs, a score S using observed and expected pairs may be calculated for every possible pair of columns i and j:

$$S = {\sum }_{N = 1}^{N = L} {( {N}_{OBS} - {N}_{EXP} )}^{2} / N$$

where L is the list of all observed pairs and N_{obs} is the number of occurrences for a pair of residues. The expected number for the pair is given by:

N_{EXP}=(CₓᵢC_{yj})/N_{valid}

in which N_{valid} is the number of sequences in the alignment that are non-gap residues, Cₓᵢ is the observed number of residue x at position i, and C_{yj} is the observed number of residues y at position j. The expected number of column pairs calculated in this manner provides a reasonable null model for comparisons of the observed pairs.

Covarying positions may be defined, for example, as those pairs with scores greater or equal to 0.5. This corresponds to a difference of at least 3 observed covarying pairs between the observed and expected in an alignment of 16 sequences. While this choice is arbitrary, it provides a reasonable number of comparisons across the phenotype classes. Accordingly, an OMES score of 0.5 may be used as the cutoff value based on the foregoing analysis. In other cases, a different OMES score may be calculated if a difference other than at least 3 observed covarying pairs between the observed and expected is used.

A reference responder network is based on graphing covariant pairs identified from a reference responder alignment and connections among the various pairs, whereas a reference non-responder network is based on graphing covariant pairs identified from a reference non-responder alignment and their connections. By way of example, a reference responder network may be based on graphing covariant pairs identified from a HCV reference responder alignment and connections among the various pairs, whereas a reference non-responder network may be based on graphing covariant pairs identified from a HCV reference non-responder alignment and their connections. For instance, a reference responder network may be based on graphing covariant pairs identified from a HCV genotype 1a reference responder alignment based on sequences of, e.g., 15 HCV 1a responding isolates and connections among the various pairs, whereas a reference non-responder network may be based on graphing covariant pairs identified from a HCV 1a reference non-responder alignment based on sequences of, e.g., 15 HCV 1a non-responding isolates and their connections.

In a further example, a reference responder network may be based on graphing covariant pairs identified from a HCV genotype 1b reference responder alignment based on sequences of, e.g., 15 HCV 1b responding isolates and connections among the various pairs, whereas a reference non-responder network may be based on graphing covariant pairs identified from a HCV 1b reference non-responder alignment based on sequences of, e.g., 15 HCV 1b nonresponding isolates and their connections. In still another example, a reference responder network is based on graphing covariant pairs identified from a HBV reference responder alignment based on sequences of, e.g., 15 HBV responding isolates and connections among the various pairs, whereas a reference non-responder network may be based on graphing covariant pairs identified from a HBV reference non-responder alignment based on sequences of, e.g., 15 HBV non-responding isolates and their connections.

The representative algorithm also includes the determination of a number of hydrophobic-hydrophobic interactions between covariant pairs in the reference responder network and reference non-responder network. The determination may be done in networks or in alignments after identifying covariant pairs since the networks are graphic representations of covariant pairs in alignments, and thus have the same covariant pairs. As is known in the art, hydrophobic amino acids include alanine, valine, isoleucine, leucine, methionine, phenylalanine, tryptophan, tyrosine, and cysteine. Furthermore, lysine-lysine and arginine-arginine pairs are also considered hydrophobic interactions. Depending on the size of the network, the number of hydrophobic-hydrophobic interactions between covariant pairs can be counted manually or using computer-implemented programs. For example, a computer program can be linked to the network to determine which position pairs to count in order to obtain the number of hydrophobic-hydrophobic interactions between covariant pairs.

Following this, the effects of a test virus on the responder and non-responder networks are determined. In one example, the test virus is HCV isolated from a subject, for instance an HCV genotype 1, 2, 3, 4, 5, or 6, such as genotypes 1a, 1b, 1c, 2a, 2b, 2c, 3a, 3b, 4a, 4b, 4c, 4d, 4e, 5a, and 6a. In another example, the test virus is a Hepatitis B virus, such as any of the genotypes A, B, C, D, E, F, G, or H. The test virus may also be, for example, HIV or influenza; however, any of the viruses mentioned in the foregoing sections can be tested.

The genome of the test virus, or at least a portion thereof, is sequenced, and a test virus responder alignment is obtained by aligning an amino acid sequence of the test virus to the sequences contained in the reference responder alignment, and a test virus non-responder alignment by aligning the test virus sequence to the sequences of the non-responder alignment. By way of example, a test amino acid sequence of HCV test virus isolated from a subject may be added to 15 amino acid sequences from an HCV 1 a reference responder alignment, and to 15 amino acid sequences from an HCV 1a reference non-responder alignment. In another example, the sequence of HCV test virus isolated from a subject may be aligned to 15 sequences from a HCV 1b reference responder alignment, and to 15 sequences from an HCV 1b reference non-responder alignment. In additional examples, the sequence of HIV or HBV test virus isolated from a subject may be added to 15 sequences from an HIV or HBV reference responder alignment, and to 15 sequences from an HIV or HBV reference non-responder alignment, respectively. Covariant pairs are again identified in the test virus responder and non-responder alignments, and test virus responder and non-responder networks are established. Covariant pair identification and network displaying are performed using the same methods discussed in the above sections. Similarly, the number of hydrophobic-hydrophobic interactions in the test virus responder and non-responder networks is determined using the same methods as described above.

A comparison of at least one network metric proportional to network stability is performed between the test virus responder network and the reference responder network and between the test virus non-responder network and the reference non-responder network, respectively. An increase in the metric is indicative (or diagnostic) of the class the test sequence is predicted to belong to, and conversely a decrease in the metric predicts that the test sequence does not belong to the reference class. Empirical observations by the inventors indicate that including a responder (non-responder) test sequence in a responder (non-responder) reference network improves the network (as assessed by the metrics tested) because it reinforces the covariances observed in the reference network. In contrast, including a non-responder (responder) test sequence in a responder (non-responder) network worsens the network because it results in a loss of (and weaker in strength) covarying pairs as assessed by the named metrics.

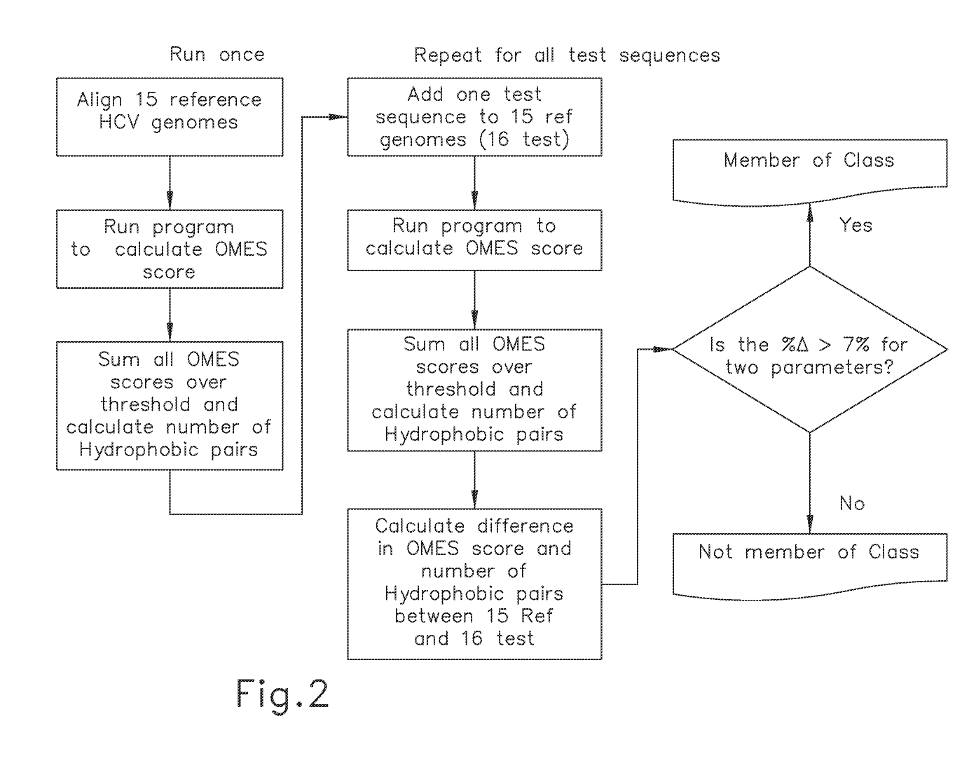

For example, if a test virus is added to 15 sequences in an alignment, a 6.7% (1/15) change by random chance is expected. Thus, obtaining a 10% difference, e.g., in the number of covariant pairs between the test virus responder network and reference responder network, indicates a significant result, a “signal strength” above random chance. A representative scheme of an algorithm for determining whether an HCV isolate belongs to a given class is illustrated in FIG. 2. A significant difference can be easily determined once the number of reference sequences to be used is determined.

An example algorithm based on the following formula only makes predictions about a viral response in two cases:

```
IF
  OMES Score (16 SVR − 15 SVR ref) > 1.07* (16 NR − 15 NR ref)
AND Hydrophobic pairs (16 SVR − 15 SVR ref) > 1.07*(16 NR − 15
NR ref)
Then call test sequence SVR
ELSE IF:
  OMES Score (16 NR − 15 NR ref) > 1.07*(16 SVR − 15 SVR ref)
AND Hydrophobic pairs (16 NR − 15 NR ref) > 1.07*(16 SVR − 15
SVR ref)
Then call test sequence NR
ELSE:
  call test sequence UNDETERMINATE
```

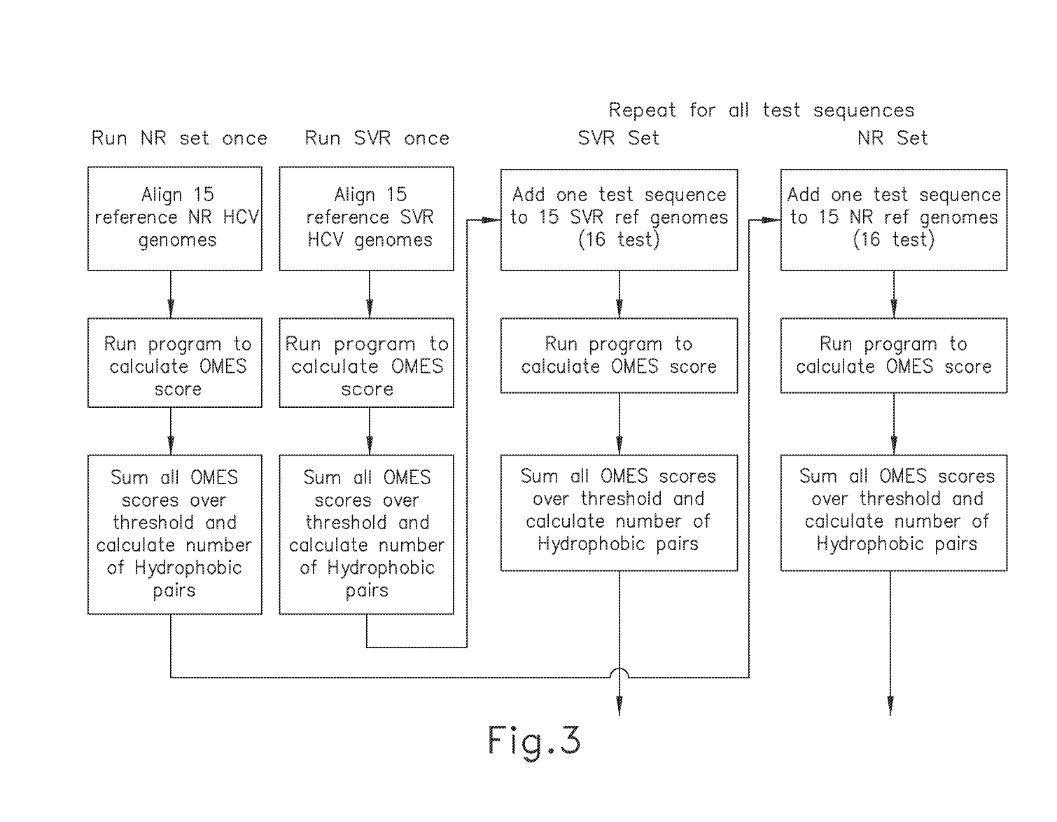

In the above example algorithm, NR designates a non-responder, SVR stands for “sustained release responder” or “responder” to indicate responder viruses, whose viral load decreases therapy and stays low. With respect to HCV (FIG. 3), SVR may refer to a virus responding to therapy such that there is undetectable virus 6 months following termination of therapy. For purposes of illustration only, the algorithm depicts a difference of greater than 7%, based on the delta that is greater than what would be expected by random chance for the addition of 1 sequence to 15 (6.7%). In other applications of the algorithm, this number may readily be determined by a skilled artisan based on the number of viral sequences that are used.

First, if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, the algorithm predicts that the test virus will respond to antiviral therapy.

Second, if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance, the algorithm predicts that the test virus will not respond to antiviral therapy. For all other combinations of differences in OMES scores and numbers of hydrophobic pairs, the algorithm makes no predictions.

Accordingly, the example algorithm can be used to predict a response of a test virus to antiviral therapy. For instance, the algorithm may be used to predict a response of HCV isolated from a subject to therapy consisting of interferon α and ribavirin, or interferon α alone. In addition, the example algorithm may be used to predict a response of HBV isolated from a subject to therapy consisting of either interferon α alone, or any combination of interferon α and nucleoside analogs. Similarly, the algorithm may be used to predict a viral response to direct acting agents that can be used in combination with interferon α, or with interferon α and ribavirin. For information on direct acting agents, for HCV see, e.g., Thompson A J, McHutchison J G: Antiviral resistance and specifically targeted therapy for HCV (STAT-C). J Viral Hepat 2009, 16:377-387; Lemon et al.: Development of novel therapies for hepatitis C. Antiviral Res 2010, 86:79-92, and Enomoto et al.: Emerging antiviral drugs for hepatitis C virus. Rev Recent Clin Trials 2009, 4:179-184.

### EXAMPLES

The methods described herein utilize laboratory techniques well known to skilled artisans, and guidance can be found in laboratory manuals such as Sambrook, J., et al., Molecular Cloning: A Laboratory Manual, 3rd ed. Cold Spring Harbor Laboratory Press, Cold Spring Harbor, N.Y., 2001; Spector, D. L. et al., Cells: A Laboratory Manual, Cold Spring Harbor Laboratory Press, Cold Spring Harbor, N.Y., 1998; and Harlow, E., Using Antibodies: A. Laboratory Manual, Cold Spring Harbor Laboratory Press, Cold Spring Harbor, N.Y., 1999, and textbooks such as Hedrickson et al., Organic Chemistry 3rd edition, McGraw Hill, New York, 1970; Carruthers, W., and Coldham, I., Modern Methods of Organic Synthesis (4th Edition), Cambridge University Press, Cambridge, U.K., 2004. Networks and network theory are discussed in references such as Barabasi, A.-L., Linked: The new science of networks, Perseus Publishing, Cambridge, Mass., 2002; Newman et al. The Structure and Dynamics of Networks, Princeton University Press, 2006; Watts, D. J., Six degrees: The science of a connected age, W. W. Norton & Company, 2003; Watts, Duncan J. Small Worlds: The Dynamics of Networks between Order and Randomness. Princeton University Press, 1999.

### Hepatitis B Network Data

HBV is as a reverse-transcribing virus with adequate genetic diversity to support covariance analysis, as it has eight genotypes that differ from each other by more than 8% (Schaefer, S., World J. Gastroenterology, 13, 14-21, 2007). Its about 3,200 nucleotides-long circular DNA genome is remarkably compact, with all nucleotides coding for protein and over half of them in two frames simultaneously (Seeger C, Zoulim F, Mason W S. Hepadnaviruses. In: Knipe D M, Howley P, Griffin D E, Lamb R A, Martin M A, Roizman B, et al., eds. Fields Virology. 5 ed. Philadelphia: Lippincott Williams & Wilkins, 2007. 2977-3029).

One hundred independent full genome sequences were obtained for each HBV genotypes B, C, and D. The amino acid sequences for each of the viral genes were extracted from their overlapping genomic positions and compiled into a single string for each viral isolate. The 100 sequences for each genotype were then aligned, yielding collinear alignments with mean pairwise identities of about 97%. All covariances within the genome were identified using the OMES method at a 1% false-discovery rate, and then pseudo-covariances stemming from changes to a single nucleotide affecting overlapping codons were manually eliminated.

About 5% of the HBV amino acid positions covaried with at least one other position, as shown in TABLE 1.

TABLE 1
Summary of HBV covariances.

| Metric | Genotype B | Genotype C | Genotype D |
|---|---|---|---|
| Total Number | 1303 | 1616 | 1255 |
| Intergenic | 43% | 49% | 60% |

The large majority (83-92% depending on genotype) of the covariances involved the viral reverse transcriptase, which accounts for approximately half of the viral coding potential. Approximately half of the covariances were intergenic, indicating that like the other viruses, there are many selective pressures that affect more than one viral protein at a time. Furthermore, the covariances formed intact networks that contained most of the covariances for each of the three genotypes.

TABLE 2
HBV network characteristics

| Genotype | Nodes | Edges/Nodes | Γ | R² |
|---|---|---|---|---|
| A | 78 | 33.6 | 0.02 | 0.001 |
| B | 106 | 30.8 | 0.146 | 0.048 |
| C | 89 | 28.2 | 0.10 | 0.172 |

The value of g was obtained from fitting to the power law distribution: log(Pr (k))=−γ log(k); R² is the correlation coefficient for the fit.

Without being bound to any particular theory, the networks appeared to all have an unusual architecture, with most nodes being very tightly interconnected, and a smaller set of nodes being less densely interconnected in each network, indicating that the HBV covariance network architecture was neither hub-and-spoke, hierarchical, nor point-to-point. This covariance network analysis indicated that, just like HCV, the amino acid covariances found within the HBV genome reflected the sum of the selective pressures on the virus and hence could be used to integrate information relevant to antiviral pressures whose effects are distributed across viral proteins or other functions encoded throughout the viral genome.

As various changes could be made in the above methods without departing from the scope of the invention, it is intended that all matter contained in the above description and shown in the accompanying figures shall be interpreted as illustrative and not in a limiting sense. In operation, computers and/or servers may execute the computer-executable instructions such as those illustrated herein to implement the above methods. The order of execution or performance of the operations in the methods illustrated and described herein is not essential, unless otherwise specified. That is, the operations may be performed in any order, unless otherwise specified, and the methods may include additional or fewer operations than those disclosed herein. For example, it is contemplated that executing or performing a particular operation before, contemporaneously with, or after another operation is within the scope of the methods.

### REFERENCES

1. Albert, R. and A. L. Barabasi. 2000. Topology of evolving networks: local events and universality. Phys. Rev. Lett. 85:5234-5237.
2. Assenov, Y., F. Ramirez, S. E. Schelhorn, T. Lengauer, and M. Albrecht. 2008. Computing topological parameters of biological networks. Bioinformatics. 24:282-284.
3. Aurora, R., M. J. Donlin, N. A. Cannon, and J. E. Tavis. 2009. Genome-wide hepatitis C virus amino acid covariance networks can predict response to antiviral therapy in humans. J. Clin. Invest. 119:225-236.
4. Baltimore, D. 1971. Expression of animal virus genomes. Bacteriol. Rev. 35:235-241.
5. Barabasi, A. L. 2002. Linked: The new science of networks. Perseus Publishing, Cambridge, Mass.
6. Barabasi, A. L. and R. Albert. 1999. Emergence of scaling in random networks. Science 286:509-512.
7. Belnap, D. M., B. M. McDermott, Jr., D. J. Filman, N. Cheng, B. L. Trus, H. J. Zuccola, V. R. Racaniello, J. M. Hogle, and A. C. Steven. 2000. Three-dimensional structure of poliovirus receptor bound to poliovirus. Proc. Natl. Acad. Sci. U.S.A 97:73-78.
8. Belyi, V. A., A. J. Levine, and A. M. Skalka. 2010. Unexpected inheritance: multiple integrations of ancient bornavirus and ebolavirus/marburgvirus sequences in vertebrate genomes. PLoS. Pathog. 6:e1001030.
9. Bottcher, B., S. A. Wynne, and R. A. Crowther. 1997. Determination of the fold of the core protein of hepatitis B virus by electron cryomicroscopy. Nature (London) 386:88-94.
10. Callaway, D. S., J. E. Hopcroft, J. M. Kleinberg, M. E. Newman, and S. H. Strogatz. 2001. Are randomly grown graphs really random? Phys. Rev. E. Stat. Nonlin. Soft. Matter Phys. 64:041902.
11. Campo, D. S., Z. Dimitrova, R. J. Mitchell, J. Lara, and Y. Khudyakov. 2008. Coordinated evolution of the hepatitis C virus. Proc. Natl. Acad. Sci. U.S.A 105:9685-9690.
12. Cannon, N. A., M. J. Donlin, X. Fan, R. Aurora, and J. E. Tavis. 2008. Hepatitis C virus diversity and evolution in the full open-reading frame during antiviral therapy. PLoS ONE 3:e2123.
13. Chang, L. J., R. C. Hirsch, D. Ganem, and H. E. Varmus. 1990. Effects of insertional and point mutations on the functions of the duck hepatitis B virus polymerase. J. Virol. 64:5553-5558.
14. Christensen, C. and R. Albert. 2007. Using graph concepts to understand the organization of complex systems. International Journal of Bifurcation and Chaos 17:2201-2214.
15. Conjeevaram, H. S., M. W. Fried, L. J. Jeffers, N. A. Terrault, T. E. Wiley-Lucas, N. Afdhal, R. S. Brown, S. H. Belle, J. H. Hoofnagle, D. E. Kleiner, and C. D. Howell. 2006. Peginterferon and ribavirin treatment in African American and Caucasian American patients with hepatitis C genotype 1. Gastroenterology 131:470-477.
16. Crowther, R. A., N. A. Kiselev, B. Bottcher, J. A. Berriman, G. P. Borisova, V. Ose, and P. Pumpens. 1994. Three-Dimensional Structure of Hepatitis B Virus Core Particles Determined by Electron Cryomycroscopy. Cell 77:943-950.
17. Das, K., X. Xiong, H. Yang, C. E. Westland, C. S. Gibbs, S. G. Sarafianos, and E. Arnold. 2001. Molecular modeling and biochemical characterization reveal the mechanism of hepatitis B virus polymerase resistance to lamivudine (3TC) and emtricitabine (FTC). J. Virol. 75:4771-4779.
18. Delmas, O., E. C. Holmes, C. Talbi, F. Larrous, L. Dacheux, C. Bouchier, and H. Bourhy. 2008. Genomic diversity and evolution of the lyssaviruses. PLoS ONE 3:e2057.
19. Deyde, V. M., M. L. Khristova, P. E. Rollin, T. G. Ksiazek, and S. T. Nichol. 2006. Crimean-Congo hemorrhagic fever virus genomics and global diversity. J. Virol. 80:8834-8842.
20. Dong, J. and S. Horvath. 2007. Understanding network concepts in modules. BMC. Syst. Biol. 1:24.
21. Donlin, M. J., N. A. Cannon, E. Yao, J. Li, A. Wahed, M. W. Taylor, S. H. Belle, A. M. Di Bisceglie, R. Aurora, and J. E. Tavis. 2007. Pretreatment sequence diversity differences in the full-length Hepatitis C Virus open reading frame correlate with early response to therapy. J. Virol. 81:8211-8224.
22. Dryden, K. A., S. F. Wieland, C. Whitten-Bauer, J. L. Gerin, F. V. Chisari, and M. Yeager. 2006. Native hepatitis B virions and capsids visualized by electron cryomicroscopy. Mol. Cell 22:843-850.
23. Edgar, R. C. 2004. MUSCLE: a multiple sequence alignment method with reduced time and space complexity. BMC. Bioinformatics. 5:113.
24. Elena, S. F., R. V. Sole, and J. Sardanyes. 2010. Simple genomes, complex interactions: epistasis in RNA virus. Chaos. 20:026106.
25. Emerson, S. U. and R. H. Purcell. 2007. Hepatitis E Virus, p. 3047-3058. In D. M. Knipe and P. Howley (ed.), Fields Virology. Lippincott Williams & Wilkins, Philadelphia.
26. Gobel, U., C. Sander, R. Schneider, and A. Valencia. 1994. Correlated mutations and residue contacts in proteins. Proteins 18:309-317.
27. Goodfellow, I., Y. Chaudhry, A. Richardson, J. Meredith, J. W. Almond, W. Barclay, and D. J. Evans. 2000. Identification of a cis-acting replication element within the poliovirus coding region. J. Virol. 74:4590-4600.
28. Gubler, D., G. Kuno, and L. Markoff. 2007. Flaviviruses, p. 1153-1252. In D. M. Knipe and P. Howley (ed.), Fields Virology. Lippencott Williams & Wilkins, Philadelphia.
29. Hogle, J. M., M. Chow, and D. J. Filman. 1985. Three-dimensional structure of poliovirus at 2.9 A resolution. Science 229:1358-1365.
30. Hollinger, F. B. and S. U. Emerson. 2007. Hepatitis A Virus, p. 911-948. In D. M. Knipe and P. Howley (ed.), Fields Virology. Lippincott Williams & Wilkins, Philadelphia.
31. Holmes, E. C. 2003. Molecular clocks and the puzzle of RNA virus origins. J. Virol. 77:3893-3897.
32. Holmes, E. C. 2008. Evolutionary history and phylogeography of human viruses. Annu. Rev. Microbiol. 62:307-328.
33. Holmes, E. C. and A. Rambaut. 2004. Viral evolution and the emergence of SARS coronavirus. Philos. Trans. R. Soc. Lond B Biol. Sci. 359:1059-1065.
34. Honda, M., M. R. Beard, L. H. Ping, and S. M. Lemon. 1999. A phylogenetically conserved stem-loop structure at the 5′ border of the internal ribosome entry site of hepatitis C virus is required for cap-independent viral translation. J. Virol. 73:1165-1174.
35. Horie, M., T. Honda, Y. Suzuki, Y. Kobayashi, T. Daito, T. Oshida, K. Ikuta, P. Jern, T. Gojobori, J. M. Coffin, and K. Tomonaga. 2010. Endogenous non-retroviral RNA virus elements in mammalian genomes. Nature 463:84-87.
36. Huang, Z., Y. Wu, J. Robertson, L. Feng, R. L. Malmberg, and L. Cai. 2008. Fast and accurate search for non-coding RNA pseudoknot structures in genomes. Bioinformatics. 24:2281-2287.
37. Khudyakov, Y. 2010. Coevolution and HBV drug resistance. Antivir. Ther. 15:505-515.
38. Kramvis, A., M. Kew, and G. Francois. 2005. Hepatitis B virus genotypes. Vaccine 23:2409-2423.
39. Kurbanov, F., Y. Tanaka, and M. Mizokami. 2010. Geographical and genetic diversity of the human hepatitis B virus. Hepatol. Res. 40:14-30.
40. Langley, D. R., A. W. Walsh, C. J. Baldick, B. J. Eggers, R. E. Rose, S. M. Levine, A. J. Kapur, R. J. Colonno, and D. J. Tenney. 2007. Inhibition of hepatitis B virus polymerase by entecavir. J. Virol. 81:3992-4001.
41. Lara, J., G. Xia, M. Purdy, and Y. Khudyakov. 2011. Coevolution of the hepatitis C virus polyprotein sites in patients on combined pegylated interferon and ribavirin therapy. J. Virol. 85:3649-3663.
42. Larson, S. M., A. A. Di Nardo, and A. R. Davidson. 2000. Analysis of covariation in an SH3 domain sequence alignment: applications in tertiary contact prediction and the design of compensating hydrophobic core substitutions. J. Mol. Biol. 303:433-446.
43. Lemon, S. M., C. Walker, M. J. Alter, and M. Yi. 2007. Hepatitis C Virus, p. 1253-1304. In D. M. Knipe, P. Howley, D. E. Griffin, R. A. Lamb, M. A. Martin, B. Roizman, and S. E. Straus (ed.), Fields Virology. Lippincott Williams & Wilkins, Philadelphia.
44. Loeb, D. D., R. C. Hirsch, and D. Ganem. 1991. Sequence-independent RNA cleavages generate the primers for plus strand DNA synthesis in hepatitis B viruses: implications for other reverse transcribing elements. EMBO J. 10:3533-3540.
45. Lyles, D. and R. Rupprecht. 2007. Rhabdoviridae, p. 1363-1408. In D. M. Knipe and P. Howley (ed.), Fields Virology. Lippincott Williams & Wilkins, Philadelphia.
46. Martinez-Salas, E. 2008. The impact of RNA structure on picornavirus IRES activity. Trends Microbiol. 16:230-237.
47. Milne, I., D. Lindner, M. Bayer, D. Husmeier, G. McGuire, D. F. Marshall, and F. Wright. 2009. TOPALi v2: a rich graphical interface for evolutionary analyses of multiple alignments on HPC clusters and multi-core desktops. Bioinformatics. 25:126-127.
48. Mizokami, M., E. Orito, K. Ohba, K. Ikeo, J. Y. Lau, and T. Gojobori. 1997. Constrained evolution with respect to gene overlap of hepatitis B virus. J. Mol. Evol. 44 Suppl 1:S83-S90.
49. Morel, V., C. Fournier, C. Francois, E. Brochot, F. Helle, G. Duverlie, and S. Castelain. 2011. Genetic recombination of the hepatitis C virus: clinical implications. J. Viral Hepat. 18:77-83.
50. Moss, E. G. and V. R. Racaniello. 1991. Host range determinants located on the interior of the poliovirus capsid. EMBO J. 10:1067-1074.
51. Nacher, J. C. and T. Akutsu. 2007. Recent progress on the analysis of power-law features in complex cellular networks. Cell Biochem. Biophys. 49:37-47.
52. Nassal, M. 2008. Hepatitis B viruses: reverse transcription a different way. Virus Res. 134:235-249.
53. Olmea, O., B. Rost, and A. Valencia. 1999. Effective use of sequence correlation and conservation in fold recognition. J. Mol. Biol. 293:1221-1239.
54. Pallansch, M. and R. Roos. 2007. Enteroviruses: Polioviruses, coxsackievirueses, echoviruses, and newer enteroviruses, p. 839-893. In D. M. Knipe, P. Howley, D. E. Griffin, R. A. Lamb, M. A. Martin, B. Roizman, and S. E. Straus (ed.), Fields Virology. Lippincott Williams & Wilkins, Philadelphia.
55. Pickett, B. E. and E. J. Lefkowitz. 2009. Recombination in West Nile Virus: minimal contribution to genomic diversity. Virol. J. 6:165.
56. Pond, S. L. and S. D. Frost. 2005. Datamonkey: rapid detection of selective pressure on individual sites of codon alignments. Bioinformatics. 21:2531-2533.
57. Purdy, M. A. and Y. E. Khudyakov. 2010. Evolutionary history and population dynamics of hepatitis E virus. PLoS. ONE. 5:e14376.
58. Purdy, M. A. and Y. E. Khudyakov. 2011. The molecular epidemiology of hepatitis E virus infection. Virus Res.
59. Racaniello, V. R. 2007. Picornaviridae: The viruses and their replication, p. 795-838. In D. M. Knipe, P. M. Howley, D. E. Griffin, R. A. Lamb, M. A. Martin, B. Roizman, and S. E. Straus (ed.), Fields Virology. Lippincott Williams & Wilkins, Philadelphia.
60. Reshetnyak, V. I., T. I. Karlovich, and L. U. Ilchenko. 2008. Hepatitis G virus. World J. Gastroenterol. 14:4725-4734.
61. Roseman, A. M., J. A. Berriman, S. A. Wynne, P. J. Butler, and R. A. Crowther. 2005. A structural model for maturation of the hepatitis B virus core. Proc. Natl. Acad. Sci. U.S.A 102:15821-15826.
62. Schmaljohn, C. and S. Nichol. 2007. Bunyaviridae, p. 1741-1790. In D. M. Knipe and P. Howley (ed.), Fields Virology. Lippincott Williams & Wilkin, Philadelphia.
63. Seeger, C., F. Zoulim, and W. S. Mason. 2007. Hepadnaviruses, p. 2977-3029. In D. M. Knipe, P. Howley, D. E. Griffin, R. A. Lamb, M. A. Martin, B. Roizman, and S. E. Straus (ed.), Fields Virology. Lippincott Williams & Wilkins, Philadelphia.
64. Seitz, S., S. Urban, C. Antoni, and B. Bottcher. 2007. Cryo-electron microscopy of hepatitis B virions reveals variability in envelope capsid interactions. EMBO J. 26:4160-4167.
65. Servant-Delmas, A., J. J. Lefrere, F. Morinet, and S. Pillet. 2010. Advances in human B19 erythrovirus biology. J. Virol. 84:9658-9665.
66. Shackelton, L. A., K. Hoelzer, C. R. Parrish, and E. C. Holmes. 2007. Comparative analysis reveals frequent recombination in the parvoviruses. J. Gen. Virol. 88:3294-3301.
67. Shannon, P., A. Markiel, O. Ozier, N. S. Baliga, J. T. Wang, D. Ramage, N. Amin, B. Schwikowski, and T. Ideker. 2003. Cytoscape: a software environment for integrated models of biomolecular interaction networks. Genome Res. 13:2498-2504.
68. Simmonds, P. 2004. Genetic diversity and evolution of hepatitis C virus—15 years on. J. Gen. Virol. 85:3173-3188.
69. Stevens, S. G., P. P. Gardner, and C. Brown. 2011. Two covariance models for iron-responsive elements. RNA. Biol. 8.
70. Tavis, J. E. and M. P. Badtke. 2009. Hepadnaviral Genomic Replication, p. 129-143. In C. E. Cameron, M. Götte, and K. D. Raney (ed.), Viral Genome Replication. Springer Science+Business Media, LLC, New York.
71. Taylor, J. M., P. Farci, and R. H. Purcell. 2007. Hepatitis D (Delta) Virus, p. 3031-3046. In D. M. Knipe and P. Howley (ed.), Fields Virology. Lippincott Williams & Wilkins, Philadelphia.
72. Watts, N. R., J. F. Conway, N. Cheng, S. J. Stahl, A. C. Steven, and P. T. Wingfield. 2011. Role of the Propeptide in Controlling Conformation and Assembly State of Hepatitis B Virus e-Antigen. J. Mol. Biol. 409:202-213.
73. Weile, C., P. P. Gardner, M. M. Hedegaard, and J. Vinther. 2007. Use of tiling array data and RNA secondary structure predictions to identify noncoding RNA genes. BMC. Genomics 8:244.
74. Wright, P. F., G. Neumann, and Y. Kawaoka. 2007. Orthomyxoviruses, p. 1691-1740. In D. M. Knipe and P. Howley (ed.), Fields Virology. Lippincott Williams & Wilkins, Philadelphia.
75. Wynne, S. A., R. A. Crowther, and A. G. Leslie. 1999. The crystal structure of the human hepatitis B virus capsid. Molecular Cell 3:771-780.
76. Zhou, Y. and E. C. Holmes. 2007. Bayesian estimates of the evolutionary rate and age of hepatitis B virus. J. Mol. Evol. 65:197-205.

1. A method for screening a test virus in a subject for responsiveness to an antiviral therapy, the method comprising the steps of:
sequencing at least a portion of the genome of the test virus contained in a biological sample from the subject;
aligning a test sequence from the test virus to the sequences of a reference responder alignment, to form a test virus responder alignment, and generating a test virus responder network based on covariance pairs identified in the test virus responder alignment;
aligning the test sequence to the sequences of a reference non-responder alignment, to form a test virus non-responder alignment, and generating a test virus non-responder network based on covariance pairs identified in the test virus non-responder alignment;
measuring a responder difference between the test virus responder network and a reference responder network and comparing the responder difference to a reference responder difference;
measuring a non-responder difference between the test virus non-responder network and a reference non-responder network and comparing the non-responder difference to a reference non-responder difference,
wherein a responder difference greater than the non-responder difference indicates that the test virus is responsive to the antiviral therapy.

2. The method of claim 1, wherein the responder difference and non-responder difference are each measured with at least one metric selected from the group consisting of: metrics measuring a characteristic of nodes; metrics measuring a characteristic of edges, and metrics measuring a topology of networks.

3. The method of claim 1, wherein the responder difference and non-responder difference are each measured with at least one metric measuring a characteristic of nodes, wherein the metric is selected from the group consisting of: alignment position, centrality, amino acid identity, polarity, hydrophobicity, aliphatic character, and electric charge.

4. The method of claim 1, wherein the responder difference and non-responder difference are each measured with at least one metric measuring a characteristic of edges, wherein the metric is selected from the group consisting of: number of edges, average edge length, number of sub-networks, edge weight, and number of hydrophobic pairs.

5. The method of claim 1, wherein the responder difference and non-responder difference are each measured with at least one metric measuring a topology of networks, wherein the metric is selected from the group consisting of γ-order, diameter, and edge density.

6. The method of claim 1, wherein the responder difference and non-responder difference are each measured by at least a covariance quantification algorithm and a by counting the number of hydrophobic pairs in a network.

7. The method of claim 6, wherein the covariance quantification algorithm is the OMES method.

8. The method of claim 1, wherein the reference responder alignment comprises 5 to 30 aligned sequences.

9. The method of claim 1, wherein the reference non-responder alignment comprises 5 to 30 aligned sequences.

10. The method of claim 1, wherein the reference responder alignment and the reference non-responder alignment each comprise amino acid translations of virus open reading frames.

11. A method for screening a test virus in a subject for responsiveness to an antiviral therapy, the method comprising the steps of:
sequencing at least a portion of the genome of the test virus contained in a biological sample from the subject;
aligning a test sequence from the test virus to the sequences of a reference responder alignment, to form a test virus responder alignment, and generating a test virus responder network based on covariance pairs identified in the test virus responder alignment;
aligning the test sequence to the sequences of a reference non-responder alignment, to form a test virus non-responder alignment, and generating a test virus non-responder network based on covariance pairs identified in the test virus non-responder alignment;
measuring a responder difference between the test virus responder network and a reference responder network and comparing the responder difference to a reference responder difference;
measuring a non-responder difference between the test virus non-responder network and a reference non-responder network and comparing the non-responder difference to a reference non-responder difference,
wherein:
the responder difference and the non-responder difference are each measured with the OMES score and the number of hydrophobic pairs, and
as measured by both OMES score and number of hydrophobic pairs, a responder difference greater than the non-responder difference indicates that the test virus is responsive to the antiviral therapy.

12. The method of claim 11, wherein:
the test virus is HCV, and
the reference responder alignment and the reference non-responder alignment each comprise amino acid translations of HCV open reading frames.

13. The method of claim 11, wherein:
the test virus is HCV, and
the reference responder alignment comprises at least 15 amino acid sequences from responding HCV isolates, and the reference non-responder alignment comprises at least 15 amino acid sequences from non-responding HCV isolates.

14. The method of claim 13, wherein the amino acid sequences of the reference responder alignment and of the reference non-responder alignment are from HCV 1a isolates.

15. The method of claim 13, wherein the amino acid sequences of the reference responder alignment and of the reference non-responder alignment are from HCV 1b isolates.

16. The method of claim 11, wherein:
the test virus is HBV, and
the reference responder alignment comprises at least 15 amino acid sequences from responding HBV isolates, and the reference non-responder alignment comprises at least 15 amino acid sequences from non-responding HBV isolates.

17. The method of claim 16, wherein the reference responder alignment and the reference non-responder alignment each comprise amino acid translations of HBV open reading frames.

18. The method of claim 16, wherein the reference responder alignment comprises at least 15 amino acid sequences from responding HBV isolates, and the reference non-responder alignment comprises at least 15 amino acid sequences from non-responding HBV isolates.

19. The method of claim 16, wherein the amino acid sequences of the reference responder alignment and of the reference non-responder alignment are from HBV isolates of a genotype selected from the group consisting of HBV genotypes A, B, C, D, E, F, G, and H.

20. A system for screening test viruses for responsiveness to an antiviral therapy, comprising:
means for sequencing test virus genes;
a computer readable memory medium, and
at least one processor operable to access from the computer readable memory medium program instructions executable by the processor to:
align a test sequence from a test virus to the sequences of a reference responder alignment, to form a test virus responder alignment, and display a test virus responder network based on covariance pairs identified in the test virus responder alignment;
align the test sequence to the sequences of a reference non-responder alignment, to form a test virus non-responder alignment, and generate a test virus non-responder network based on covariance pairs identified in the test virus non-responder alignment;
measure a responder difference between the test virus responder network and a reference responder network and compare the responder difference to a reference responder difference;
measure a non-responder difference between the test virus non-responder network and a reference non-responder network and compare the non-responder difference to a reference non-responder difference.
